(19) United States
(12) Patent Application Publication
(10) Pub. No.: US 2005/0155173 A1
(43) Pub. Date: Jul. 21, 2005

(54) Rubber doormat and method of making the same

(76) Inventors: Bill Ramsey, Ringgold, GA (US); Kevin Whiteside, Ringgold, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/761,121

(22) Filed: Jan. 20, 2004

(51) Int. Cl. A47L 23/22; B29C 67/04; B29C 43/02; B05D 7/00

(52) U.S. Cl. 15/215; 264/126; 264/131; 264/132; 427/428.01; 427/372.2

(57) ABSTRACT

A method for the manufacture of ornamental rubber mats comprises the steps of providing a rubber member having an area for wiping the feet, the feet wiping area including a three-dimensional pattern having contoured surface portions, and applying a colored adhesive to at least one selected contoured surface portion of said three-dimensional pattern. The colored adhesive comprises a urethane base component, a pigment component, and an abrasive component. Once the colored adhesive is applied to the contoured surface, the colored adhesive is allowed to cure. A preferred embodiment of an ornamental doormat for wiping feet comprises a rubber member having an area for wiping feet, the feet wiping area including a three-dimensional pattern having contoured surface portions; and a colored adhesive adhered to at least one selected contoured surface portion, the colored adhesive including a urethane base component, a pigment component, and an abrasive component.

### BACKGROUND OF THE INVENTION

1. Field of the Invention

The present invention relates generally to doormats and, more particularly, to rubber doormats having intricate contoured and colored surfaces and method of making the same.

2. Description of the Related Art

Doormats are commonly found at the entrance of a dwelling so that a person may wipe their feet prior to entering. Accordingly, doormats are often used on porches of houses, and at the entrances of businesses, hospitals, schools, hotels, offices, and the like, to prevent dust and dirt from being tracked indoors on the soles of shoes. Such mats typically have an abrasive surface in order to effectively fulfill their purpose. Abrasive qualities have been incorporated into doormats through a variety of methods such as incorporating fabric or fibers into the mat or providing corrugations or projections on the surface.

Because doormats are commonly used outdoors, manufacturers have endeavored to design doormats that can withstand prolonged exposure to the elements. Although a variety of materials have been used to achieve this goal, one of the most successful materials is rubber. Rubber is a preferable material because of its durability and strength. It is also resilient and non-biodegradable. These and other characteristics make it highly weather resistant and a suitable material for manufacturing doormats. As such, rubber doormats are commonly made from recycled tires that have been ground into rubber particles. These rubber particles are sprinkled into a mold, and then heated and pressurized until the rubber cures and takes on the mold's shape. The molding process also allows for the production of doormats with raised and/or recessed designs on the surface so that a person using them can effectively wipe their feet.

In addition to preventing the tracking of dirt into a dwelling, doormats often serve a decorative purpose as well. For example, doormats are known to have various colors, pictures, logos, and/or writing thereon. In fact, it is quite common for doormats to have the word “welcome” on them, which has led to them commonly being referred to as “welcome mats.” As the decorative appeal of doormats has increased in popularity, the demand for doormats with aesthetic, as well as, functional qualities has greatly increased. Accordingly, manufacturers have endeavored to design doormats that have decorative appeal while maintaining functional value in order to meet this high demand.

In the case of rubber doormats, it is common in the industry to produce a doormat with a molded ornamental pattern on the surface, and then apply color to the molded surface for an even more decorative effect. This is done through a flocking process that is generally described as follows. A mold is designed that will produce a rubber doormat having an ornamental design or pattern on the surface, and a molded rubber doormat is produced using the mold. An adhesive is then applied to portions of the ornamental surface. Following application of the adhesive, a white flock is sprinkled onto the doormat and adheres to those portions of the surface that have the adhesive. The flock is necessary for applying pigment to the surface of the rubber doormat because the pigment itself will not stick to the rubber. The pigment is transferred to the flock through a heat transferred color pattern, or silk screen. The entire mat is then cured to allow the adhesive, and now colored flock, to set and dry.

Although the doormats produced by the above process are useful for their intended purpose, they are not without limitations. In use, the flock eventually wears off through exposure to the elements, cleaning, and regular use of the doormat. Another disadvantage of using flock to color doormats is that its application is normally limited to generally planar surfaces because it quickly and unevenly wears off through regular use if the surface to which it is applied is contoured. Thus, when flock is used to color a raised ornamental design on the surface of a rubber doormat, the flock is only applied to non-contoured or generally planar portions of the raised ornamental design in order to prevent uneven wear. The more planar the surface of the doormat is, however, the less effective it is for wiping the feet. Accordingly, the use of flock greatly limits the variety of raised three-dimensional surface designs that can be molded into rubber doormats and hinders the functional effectiveness of the doormat.

What is needed then is a method of manufacturing an ornamental rubber doormat having a raised three-dimensional, contoured pattern on the surface of the doormat, and adding color to the contoured surface portions of the pattern without resorting to the flocking technique described above, while maintaining the functional attributes of the doormat. It is to such a method, and doormats produced by the method, that the present invention is directed.

### SUMMARY OF THE INVENTION

A method for the manufacture of ornamental rubber mats comprises the steps of providing a rubber member having an area for wiping the feet, the feet wiping area including a three-dimensional pattern having contoured surface portions, and applying a colored adhesive to at least one selected contoured surface portion of the three-dimensional pattern. The colored adhesive comprises a urethane base component, a pigment component, and an abrasive component. Once the colored adhesive is applied to the contoured surface, the colored adhesive is allowed to cure.

The step of providing a rubber member having a contoured surface thereon comprises providing a mold for producing a three-dimensional pattern having contoured surface portions; adding rubber particles to the mold; heating and pressurizing the rubber particles in the mold to form a molded rubber member having a surface, wherein the contoured design is formed on at least one portion of the surface; and removing the rubber member from the mold.

The process step of applying a colored adhesive to a selected portion of the contoured surface of the rubber member comprises applying the colored adhesive to at least one roller; and rolling the colored adhesive onto a selected portion of the contoured surface of the rubber member while maintaining pressure on the roller. Once the colored adhesive has been applied, the colored adhesive is allowed to cure by heating the rubber member or by allowing the rubber member to air dry.

A preferred embodiment of an ornamental doormat for wiping feet comprises a rubber member having an area for wiping feet, the feet wiping area including a three-dimensional pattern having contoured surface portions; and a colored adhesive adhered to at least one selected contoured surface portion, the colored adhesive including a urethane base component, a pigment component, and an abrasive component.

### BRIEF DESCRIPTION OF THE FIGURES

FIG. 1 is a perspective view of a preferred embodiment of the present invention.

FIG. 2A is a flow chart illustrating the steps of the method of the present invention.

FIG. 2B is a side view of a system for carrying out the method of the present invention.

FIG. 2C is a flow chart demonstrating the sub-steps of one of the steps in FIG. 2.

FIG. 3 is a top view of the preferred embodiment in FIG. 1.

FIG. 4 is a cross sectional view of the preferred embodiment in FIG. 1.

### DETAILED DESCRIPTION OF THE PREFERRED EMBODIMENTS

The invention is a novel method of manufacturing an ornamental rubber doormat having a three-dimensional pattern with contoured surface portions, and adding color to the contoured surface portions without resorting to the use of flock, while maintaining the functional attributes of the doormat. The invention is more versatile than previous flocking techniques because it allows for more even wear of colored, contoured surfaces. A preferred embodiment of a doormat manufactured using the described method has a three dimensional serpentine or scroll design having underlaytions and arcuate contoured portions. Accordingly, the doormats manufactured by the disclosed method have colored surfaces that are contoured rather than being limited to colored surface portions that are substantially planar.

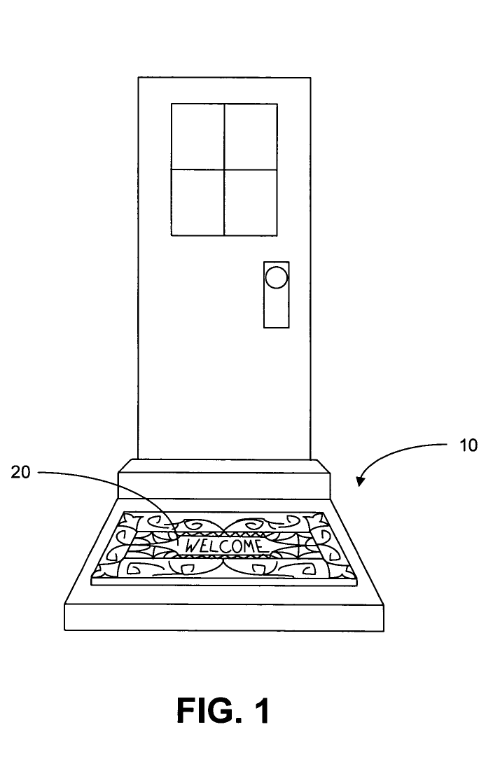

Referring now in detail to the drawing figures, FIG. 1 illustrates a perspective view of a preferred embodiment manufactured by the method of the present invention. As shown in FIG. 1, an ornamental doormat 10 is placed on the porch, outside of a dwelling. The doormat provides an ornamental area 20 for wiping one's feet before entering the dwelling and also adds a decorative appearance to the porch.

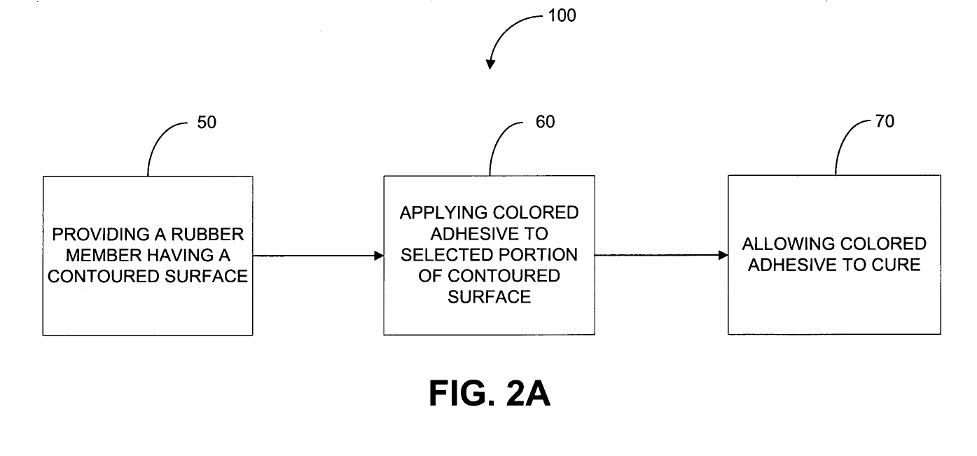

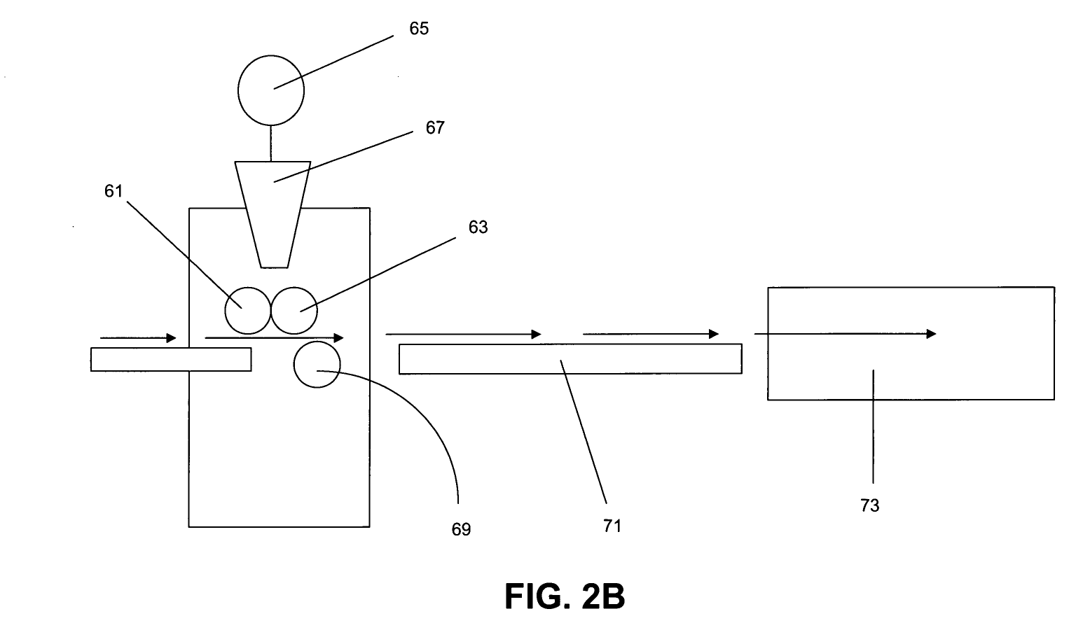

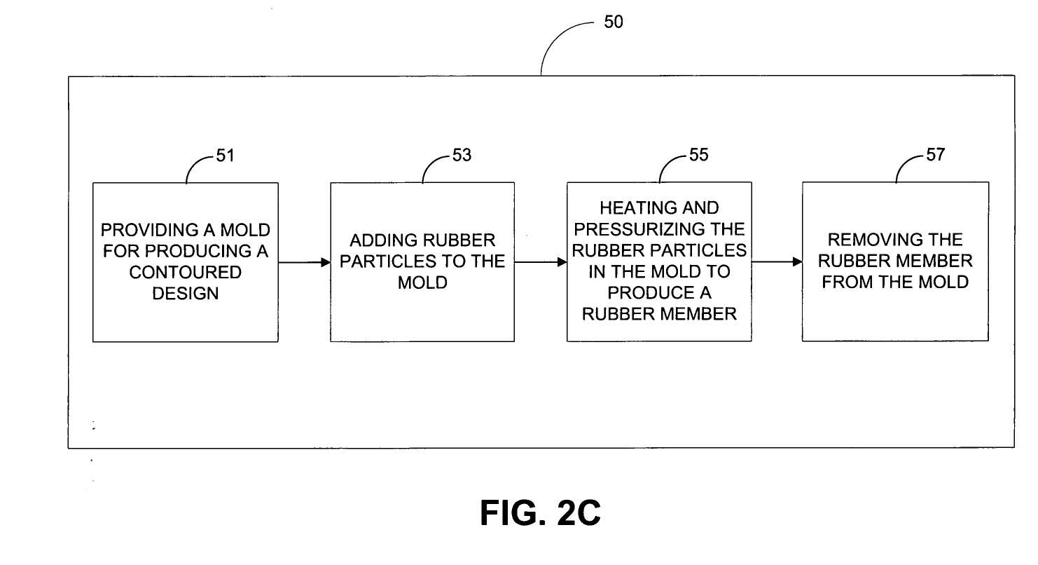

Referring now to FIGS. 2A, 2B and 2C, the method 100 for manufacturing preferred embodiments of the present invention will now be described in greater detail through flow diagrams. As shown in FIG. 2A, the method begins with the step 50 of providing a rubber member having a contoured surface. In the next step 60, a colored adhesive is applied to a selected portion of the contoured surface. Preferably, the colored adhesive is applied to at least one roller and rolled onto the contoured surface while maintaining pressure on the roller. Other methods of application are available, however, such as brushing, pouring, spraying, or dipping. Finally, the colored adhesive is allowed to cure at step 70, thereby adhering to the contours on the surface of the rubber member. Such curing may occur through heating or by allowing the colored adhesive to air dry.

As shown in FIG. 2B a simple system may be utilized to carry out the method described in FIG. 2A. A rubber member is guided into the system at metering roller 61 and brought into contact with application roller 63. The direction of flow of the rubber member is indicated by arrows. The colored adhesive is applied to the application roller 63 from mixing dispenser 67, which is in turn connected to adhesive tank 65. Application roller 63 applies the colored adhesive onto the surface of the rubber member as the rubber member is supported by base support roller 69. After application of the colored adhesive, the rubber member is conveyed to heat source 73 by conveyor 71 and allowed to cure.

A flow diagram illustrating the sub-steps for the step 50 providing the rubber member is shown in FIG. 2C. A mold is provided for producing a contoured design (sub-step 51). The chosen design may be of any pattern or shape and a computer may be utilized in creating the design. Next, rubber particles are added to the mold (sub-step 53). The mold is filled by methods that are known in the art, such as pouring, injection, or spraying. Natural or synthetic rubber or resin particles may be used, and a preferable source of rubber particles is crumb rubber ground from recycled tires. The rubber particles are then heated and pressurized while in the mold to produce a rubber member (sub-step 55). When the rubber member is removed from the mold (sub-step 57), the rubber member has a surface with the contoured design.

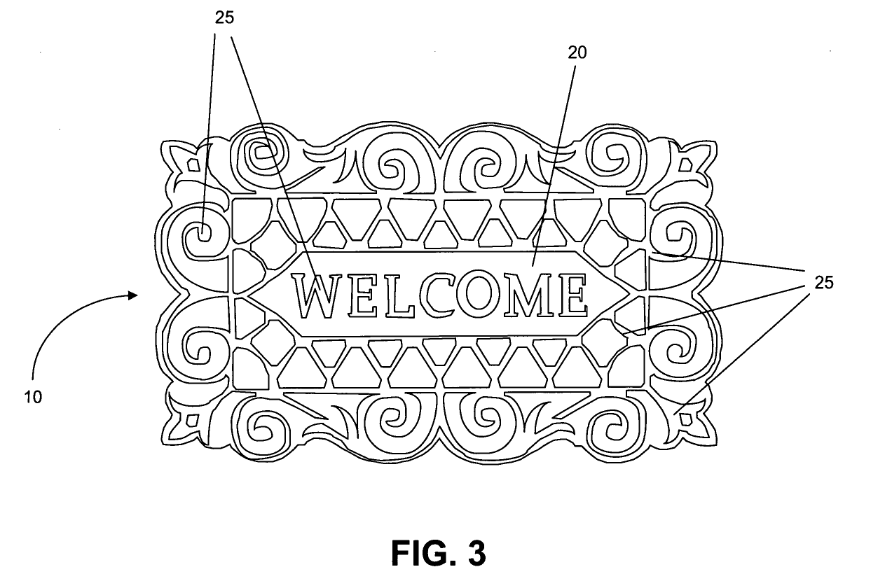

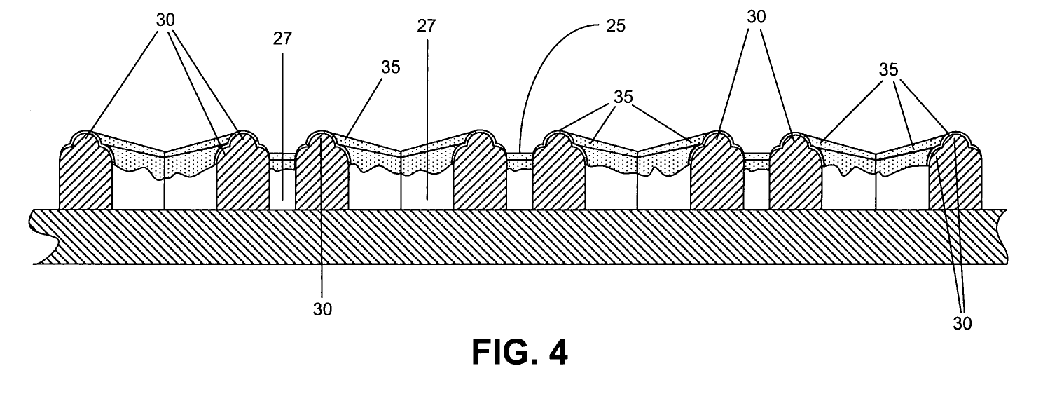

An example of such a contoured design is shown in FIG. 3, which illustrates a top view of the doormat 10 shown in FIG. 1. As can be seen by the drawing, ornamental doormat 10 has a feet wiping area 20 with a contoured pattern 25 on the surface. The contoured pattern 25 is a raised three-dimensional serpentine or scroll design having underlaytions 27 and arcuate contoured surface portions 30, as best shown in a cross-sectional view of the surface in FIG. 4. As shown in FIG. 4, a colored adhesive 35 has been applied to the contoured surface portions 30 of raised three-dimensional pattern 25 and allowed to cure. Accordingly, the colored adhesive has taken on the shape and contours of the raised three-dimensional pattern. The colored adhesive comprises a urethane base component, a pigment component, and an abrasive component. The abrasive component is pieces of polyvinylchloride (PVC), but a person of ordinary skill in the art will recognize that other abrasive filler materials are also appropriate. A suitable colored adhesive having these components may be obtained from MarChem Southeast of Adairsville, Ga. under the name of Mistabond S2000-XX.

The adhesive adds color, function and durability to the rubber doormat. The coloring enhances subtle differences in the contoured surface, enhancing the ornamental look of the doormat. Upon curing, the colored adhesive also provides a surface that is abrasive enough to grab debris when wiping the feet, yet cleans easily by shaking or hosing off. Finally, the colored adhesive adds durability to the wiping surface of the doormat. The durability has been tested using the Bettermann Drum Test. The test measures the resistance of a surface material from flaking off of the surface to which it is applied. The test is administered by striking the surface material with rotating ball bearings at speeds between 2,500 to 5,000 revolutions per minute. The results are measured on a scale from 1 to 5 with a 1 meaning that most of the material came completely off, and a 5 meaning that no visible flaking was observed. A rubber doormat manufactured using the method of the present invention measured a 5 when tested at 5,000 revolutions per minute over a ten minute period. Whereas, a typical flocked product only measures between 3.5 and 4 at 2,500 revolutions per minute over the same time period.

The method of the present invention has several advantages over the known flocking technique. First of all, as explained herein, the application of flock to produce a colored rubber doormat is generally limited to substantially planar surfaces because it quickly exhibits uneven wear if applied to contoured surfaces. Thus, the method of the present invention eliminates the flock applying step saving both time and money. Moreover, because the pigment is already in the adhesive, the step of transferring pigment to the flock through a heat transferred color pattern, or silk screen is also eliminated.

Second, the substantially planar surface requirements of the known flocking technique limit the availability of both functional and ornamental designs. The contoured surface designs produced by the method of the present invention provide a more effective surface for wiping the feet than a substantially planar surface. The abrasive component of the adhesive further contributes to this effectiveness. Virtually any texture or three-dimensional shape can be achieved simulating the look of brick, cracked stone surface, or even rounded Wrought Iron. Accordingly, a wider range of colored ornamental designs are available. Finally, as explained above, the product is more durable than a flocked product.

Accordingly, it may be seen, that a simple method may be had for manufacturing a functional yet ornamental rubber doormat having a raised three-dimensional, contoured pattern on the surface of the doormat, and adding color to the contoured surface portions of the pattern without resorting to the limited and more expensive flocking technique known in the art.

1. A process for the manufacture of ornamental rubber mats, the process comprising the steps of:
(a) providing a rubber member having an area for wiping feet, said feet wiping area including a three-dimensional pattern having contoured surface portions;
(b) applying a colored adhesive to at least one selected contoured surface portion of said three-dimensional pattern; said colored adhesive including a urethane base component, a pigment component, and an abrasive component; and
(c) allowing said colored adhesive to cure.

2. The process of claim 1, wherein step (a) providing a rubber member having an area for wiping feet, said feet wiping area including a three-dimensional pattern having contoured surface portions comprises:
providing a mold for producing a three-dimensional pattern having contoured surface portions;
adding rubber particles to said mold;
heating and pressurizing said rubber particles in said mold to form a molded rubber member having a surface, wherein said contoured design is formed on at least one portion of said surface; and
removing said rubber member from said mold.

3. The process of claim 1, wherein step (b) applying a colored adhesive to at least one selected contoured surface portion of said three-dimensional pattern comprises:
applying said colored adhesive to at least one roller; and
rolling said adhesive onto at least one selected contoured surface portion of said three-dimensional pattern while maintaining pressure on said at least one roller.

4. The process of claim 1, wherein the step (c) allowing said colored adhesive to cure comprises heating said rubber member once said colored adhesive has been applied.

5. The process of claim 1, wherein the step (c) allowing said colored adhesive to cure comprises allowing said rubber member to air dry after said colored adhesive has been applied.

6. The process of claim 1, wherein said abrasive component comprises particles of polyvinylchloride.

7. The process of claim 2, wherein said rubber particles comprises crumb rubber produced from recycled tires.

8. An ornamental doormat for wiping feet, the doormat comprising:
a rubber member having an area for wiping feet, said feet wiping area including a three-dimensional pattern having contoured surface portions; and
a colored adhesive adhered to at least one selected contoured surface portion, said colored adhesive including a urethane base component, a pigment component, and an abrasive component.

9. The ornamental doormat of claim 8, wherein said abrasive component comprises particles of polyvinylchloride.

10. The ornamental doormat of claim 8, wherein said rubber member is formed from crumb rubber produced from recycled tires.
